(19) United States
(12) Patent Application Publication
(10) Pub. No.: US 2024/0017721 A1
(43) Pub. Date: Jan. 18, 2024

(54) METHOD FOR CONTROLLING AN EGO VEHICLE

(71) Applicant: Robert Bosch GmbH, Stuttgart (DE)

(72) Inventors: Markus Schuetz, Tuebingen (DE); Steffen Knoop, Hohenwettersbach (DE); Thomas Schamm, Karlsruhe (DE)

(21) Appl. No.: 18/336,581

(22) Filed: Jun. 16, 2023

(30) Foreign Application Priority Data
Jul. 14, 2022 (DE) 10 2022 207 185.9

(51) Int. Cl. B60W 30/09

(52) U.S. Cl. CPC B60W 30/09; B60W 2556/40; B60W 2720/10; B60W 2710/20; B60W 2554/20; B60W 2555/60; B60W 2554/4044; B60W 2520/10; B60W 2520/06; B60W 2554/80; B60W 2554/4041; B60W 2554/4046; B60W 30/0956

(57) ABSTRACT

A method for controlling an ego vehicle. The method includes: receiving map data of a map display of an environment of an ego vehicle; ascertaining a safe travel corridor for the ego vehicle based on the map data of the map display; ascertaining a safety zone of the ego vehicle based on a state of movement of the ego vehicle; checking whether, when the ego vehicle is traveling along a travel trajectory, the safety zone is located entirely within the safe travel corridor; and outputting a control signal to execute a safety maneuver if the safety zone is located at least partly outside the safe travel corridor.

### CROSS REFERENCE

The present application claims the benefit under 35 U.S.C. § 119 of German Patent Application No. DE 10 2022 207 185.9 filed on Jul. 14, 2022, which is expressly incorporated herein by reference in its entirety.

### FIELD

The present invention relates to a method for controlling an ego vehicle.

### BACKGROUND INFORMATION

For the automatic control of vehicles, it is essential that the vehicle be driven safely. Numerous driver assistance systems that help to prevent a collision with other road users are described in the related art.

### SUMMARY

An object of the present invention is to provide an improved method for controlling an ego vehicle.

This object may be achieved by the method for controlling an ego vehicle according to features of the present invention. Advantageous embodiments of the present invention are disclosed herein.

According to one aspect of the present invention, a method is provided for controlling an ego vehicle. According to an example embodiment of the present invention, the method comprises:
receiving map data of a map display of an environment of an ego vehicle, the map data of the map display mapping at least one roadway along which the ego vehicle is traveling;
ascertaining a safe travel corridor for the ego vehicle based on the map data of the map display, the safe travel corridor describing a spatial area through which the ego vehicle may travel without collision, and the safe travel corridor being bounded at least by boundaries of the roadway;
ascertaining a safety zone of the ego vehicle based on a state of movement of the ego vehicle, the safety zone defining a spatial area in which the ego vehicle in a given state of movement may be safely brought to a stop;
checking whether, when the ego vehicle is traveling along a travel trajectory, the safety zone is located entirely within the safe travel corridor; and
outputting a control signal to execute a safety maneuver if the safety zone is located at least partly outside the safe travel corridor.

In this way, it may be possible to achieve the technical advantage that an improved method may be provided for controlling an ego vehicle. To this end, firstly, a safe travel corridor for the ego vehicle is calculated on the basis of map data of a map display. The safe travel corridor is a spatial area through which, according to the map display, the ego vehicle may travel without collision. The absence of collisions refers primarily here to collisions of the ego vehicle with objects located statically in the environment of the ego vehicle. In accordance with prevailing traffic regulations, the safe travel corridor is limited to the area of the roadway. The safe travel corridor is thus bounded at least by the boundaries of the roadway along which the ego vehicle is traveling. In addition to the map data of the map display, consideration may also be given to position information about the vehicle relative to the map display in order to calculate the safe travel corridor. In accordance with the present invention, in addition to the safe travel corridor, a safety zone of the ego vehicle is calculated, having regard to a state of movement of the vehicle. The safety zone of the ego vehicle describes a spatial area in which the ego vehicle in the given state of movement may be safely brought to a stop. In this context, the state of movement may include, in addition to a position or speed of the ego vehicle, a retarding power or braking power of the ego vehicle.

In accordance with an example embodiment of the present invention, in order to control the ego vehicle, a check is made to determine whether, when the ego vehicle is traveling along a planned travel trajectory, the previously calculated safety zone is located entirely within the safe travel corridor at all times.

If, however, it is ascertained that the safety zone is located at least partly outside the safe travel corridor, then according to the present invention a control signal is output to execute a safety maneuver. By taking account of the safety zone according to the present invention and by checking that the safety zone is located within the safe travel corridor, it is possible to ensure that the ego vehicle is driven safely, a safety maneuver being executed automatically as soon as the safety zone calculated in accordance with the state of movement of the ego vehicle is not located entirely within the safe travel corridor.

In accordance with an example embodiment of the present invention, the present invention, the safety zone describes a spatial area in which the ego vehicle in the given state of movement may be braked to a stop if an event occurs. If the safety zone is no longer located entirely within the safe travel corridor, however, it is not possible to guarantee that, if an unforeseen event occurs, the ego vehicle may be braked to a stop within the safe travel corridor. Upon occurrence of the event and the subsequent braking operation, the ego vehicle might thus leave the safe travel corridor, and this in turn might cause the ego vehicle to collide with objects outside the safe travel corridor.

According to an example embodiment of the present invention, both the safe travel corridor and the safety zone may be determined or calculated repeatedly while the ego vehicle is traveling along the travel trajectory. The check of the location of the safety zone within the safe travel corridor may thus likewise be repeated for different positions of the ego vehicle as it travels along the trajectory.

According to an example embodiment of the present invention, by checking that the safety zone is located within the safe travel corridor for the movement of the ego vehicle along the planned travel trajectory, it is thus possible in particular to avoid collisions that may occur as a result of incorrectly planned travel trajectories. With a travel trajectory in which the safety zone is located entirely within the safe travel corridor at all times, it is possible to ensure that, even if an unforeseen event occurs, with a resulting braking operation, the ego vehicle may be brought to a stop within the safe travel corridor. According to the present invention, the safety zone describes the spatial area that is needed in order to brake the ego vehicle to a stop in the current state of movement if an event occurs. If the safety zone is not entirely within the safe travel corridor at all times as a travel trajectory is followed, it must be assumed that if an event occurs in the positions of the travel trajectory where the safety zone is located at least partly outside the safe travel corridor, then the ego vehicle will be moved beyond the boundaries of the safe travel corridor during the braking operation and will thus at least partly leave the safe travel corridor. For such travel trajectories, it is thus no longer possible to guarantee that the ego vehicle will remain within the safe travel corridor at all times. The possibility of collisions between the ego vehicle and objects outside the safe travel corridor may therefore not be ruled out. Thus, by taking the safety zone into consideration, the safety of the control of the ego vehicle may be improved.

Within the meaning of the application, the ego vehicle may be a vehicle that is controllable in a partially automated, highly automated or fully automated manner. Road users may include other vehicles, particularly trucks, cars, buses, motorcycles, or bicycles. Within the meaning of the application, a roadway may be a freeway, a highway, an urban street, a traffic-calmed street, or a parking lot.

According to one specific example embodiment of the present invention, the safety maneuver comprises:
performing an emergency stop, where the ego vehicle, deviating from a planned travel trajectory, is brought to a safe stop;
and/or performing a speed reduction deviating from a planned travel trajectory of the ego vehicle, the speed reduction being performed in such a way that the safety zone is once more located entirely within the safe travel corridor; and/or performing a steering movement deviating from the planned travel trajectory of the ego vehicle, the steering movement being performed in such a way that the safety zone is once more located entirely within the safe travel corridor.

In this way, it may be possible to achieve the technical advantage that the safety of the control of the ego vehicle may be further improved. To this end, the safety maneuver to be performed includes an emergency stop, where the ego vehicle, deviating from the planned travel trajectory, is automatically brought to a stop. Alternatively or in addition thereto, the safety maneuver may include a speed reduction, where the ego vehicle is braked but not brought to a stop. In this case, the speed of the ego vehicle may be reduced in such a way that the safety zone is once more located entirely within the safe travel corridor. The safety zone describes the spatial area needed for braking the ego vehicle to a stop. A length of the safety zone oriented in the direction of travel of the ego vehicle thus depends inter alia on a speed of the ego vehicle. The length of the safety zone may thus be reduced by decreasing the speed of the ego vehicle. Therefore, the speed may be reduced in such a way that the correspondingly smaller safety zone is located entirely within the safe travel corridor for all positions of the planned travel trajectory. Through the reduced speed and the correspondingly reduced required braking distance of the ego vehicle, which is reflected in the length of the safety zone, it is possible in turn to ensure that, if an event occurs, the ego vehicle may be braked to a stop at all times without leaving the safe travel corridor.

Alternatively or in addition, according to an example embodiment of the present invention, a corresponding steering procedure of the ego vehicle may be performed, where, deviating from the planned travel trajectory, the vehicle is controlled in such a way that, owing to the changed direction of travel, the safety zone is once again located entirely within the safe travel corridor and, if an event occurs, the ego vehicle may be brought to a stop within the travel corridor. The safety zone describes a spatial area that is needed to brake the ego vehicle to a stop. Therefore, an orientation of the safety zone depends on the direction of travel of the ego vehicle. If the direction of travel is changed, the orientation of the safety zone in relation to the safe travel corridor, which is determined primarily by the orientation of the roadway on which the vehicle is traveling, changes accordingly. By performing a steering procedure in the form of a lateral control of the ego vehicle, it is thus possible to change the orientation of the safety zone relative to the safe travel corridor in such a way that the safety zone is once more located entirely within the safe travel corridor. The shape and/or size of the safety zone may be left largely unchanged by the steering movement of the ego vehicle.

According to one specific embodiment of the present invention, at least one static object located at least partly on the roadway is recognized by way of an object recognition performed on surround sensor data of at least one surround sensor of the ego vehicle, the safe travel corridor being bounded by the at least one static vehicle located at least partly on the roadway.

In this way, it may be possible to achieve the technical advantage that a further improvement of the safety of the ego vehicle is made possible. To this end, in addition to the information from the map display, information from an object recognition performed on surround sensor data is also taken into consideration in order to calculate the safe travel corridor. To this end, detected static objects located at least partly on the roadway on which the ego vehicle is traveling may be taken into consideration to calculate the safe travel corridor. These objects may be parked vehicles, for example, or other static objects located at the roadside which are not explicitly recorded in the map display. By taking account of such static objects located at the side of the roadway, a precise safe travel corridor may be calculated. The safe travel corridor is in this case bounded both by the roadway boundaries and by the objects located at least partly on the roadway.

According to one specific embodiment of the present invention, at least one prevailing traffic regulation is recognized by way of an object recognition performed on surround sensor data of at least one surround sensor of the ego vehicle, the safe travel corridor being bounded by the at least one recognized prevailing traffic regulation.

In this way, it may be possible to achieve the technical advantage that the safety of the control of the ego vehicle may be further improved. To this end, moreover, recognized traffic regulations are taken into consideration to calculate the safe travel corridor. For example, stop lines at stop signs may be taken into consideration to delimit the safe travel corridor.

According to one specific embodiment of the present invention, the method further comprises:
ascertaining an extended safety zone based on the state of movement of the ego vehicle and having regard to an object movement model of a dynamic object located in the safe travel corridor, the object movement model comprising a description of an average movement of dynamic objects, the extended safety zone defining a spatial area in which the ego vehicle in the given state of movement may be brought to a stop without colliding with an object which according to the object movement model is moving at least partly in the direction of the ego vehicle;
checking whether a dynamic object is located within the extended safety zone; and
outputting a control signal to execute a safety maneuver if the safety zone is located at least partly outside the safe travel corridor and/or if at least one dynamic object is located in the extended safety zone.

In this way, it may be possible to achieve the technical advantage that the safety of the ego vehicle may be further improved. To this end, an extended safety zone is calculated, by way of which dynamic objects may be taken into consideration. Like the safety zone, the extended safety zone is calculated having regard to the state of movement of the ego vehicle. Furthermore, an object movement model of dynamic objects located in the environment of the ego vehicle is taken into consideration when calculating the extended safety zone. The object movement model describes an average movement of dynamic objects located in the environment of the ego vehicle. The extended safety zone thus describes a spatial area within which the ego vehicle may move, in the given state of movement, without colliding with a dynamic object which is located in the environment of the ego vehicle and which, according to the object movement model, is moving dynamically within the environment of the ego vehicle. According to the present invention, in addition to checking that the safety zone is located within the safe travel corridor, a check is made to determine whether a dynamic object located within the environment of the ego vehicle is located within the extended safety zone. If a dynamic object is located within the extended safety zone, the aforementioned control signal to execute the safety maneuver is output. Collisions between the ego vehicle and dynamic objects may thus be prevented by the additional safety zone. This requires no prediction of the behavior of the dynamic objects. Instead, the object movement model based on the average behavior is taken into account to calculate the extended safety zone. If, while the ego vehicle is following the planned trajectory, it is ascertained that a corresponding dynamic object is located within the extended safety zone, the aforementioned safety maneuver is executed automatically. A predicted behavior of the detected object is not taken into consideration here. Taking the extended safety zone into consideration thus constitutes an effective protection of the ego vehicle ahead of the behavior prediction. Irrespective of any behavior prediction made in respect of the detected dynamic object, the ego vehicle is automatically triggered to execute the safety maneuver as soon as the detected dynamic object is located within the extended safety zone. A collision between the ego vehicle and the detected dynamic object may be prevented in this way. The dynamic objects may in this case be other road users, particularly pedestrians.

According to one specific embodiment of the present invention, the state of movement is defined at least by an item of position information and/or speed information and/or retardation information relating to a possible retarding power of the ego vehicle, a length of the safety zone oriented in a direction of travel of the ego vehicle corresponding to a distance within which, if an event occurs, the ego vehicle in the given state of movement may be brought to a stop with a maximum retarding power of the ego vehicle.

In this way, it may be possible to achieve the technical advantage that a precise safety zone may be calculated, having regard to the state of movement.

According to one specific embodiment of the present invention, a length of the extended safety zone oriented in a direction of travel of the ego vehicle and/or a width of the extended safety zone oriented perpendicularly to the direction of travel of the ego vehicle corresponds to a distance within which the ego vehicle in the given state of movement may be brought to a stop with the maximum retarding power without colliding with an object which, according to the movement model, is moving towards the ego vehicle in the opposite travel direction or in the direction perpendicular to the direction of travel.

In this way, it may be possible to achieve the technical advantage that a precise extended safety zone may be calculated, having regard to the state of movement of the ego vehicle and the movement model of the dynamic object.

According to one specific embodiment of the present invention, a width of the safety zone and/or a width of the extended safety zone oriented perpendicularly to the travel direction of the ego vehicle corresponds at least to a width of the ego vehicle.

In this way, it may be possible to achieve the technical advantage that a precise safety zone or extended safety zone may be ascertained.

According to one specific embodiment of the present invention, the safety zone and/or the extended safety zone comprises a spatial area immediately in front of and/or behind and/or alongside the ego vehicle in the direction of travel.

In this way, it may be possible to achieve the technical advantage that safety zones or extended safety zones may be calculated for different driving situations.

According to one specific embodiment of the present invention, the state of movement further comprises an item of steering information relating to a possible steering performance of the ego vehicle, the width of the safety zone being ascertained having regard to a steering inaccuracy of the ego vehicle.

In this way, it may be possible to achieve the technical advantage that steering inaccuracies may additionally be taken into consideration. In this regard, the width of the safety zone is dependent on the steering performance of the ego vehicle. The steering performance includes steering inaccuracies of the ego vehicle. Steering inaccuracies contribute to the accuracy of control of the ego vehicle. This in turn contributes to the spatial area needed to fully brake the ego vehicle. Thus, by taking the steering inaccuracies into consideration when calculating the safety zone, a precise safety zone can be calculated.

According to one specific embodiment of the present invention, the checking of the location of the safety zone within the safe travel corridor and/or the checking of the positioning of the dynamic object in the extended safety zone takes place by way of a geometric comparison between a surface area of the safety zone and a surface area of the safe travel corridor and/or by way of a geometric comparison between a surface area of the extended safety zone and a position of the dynamic object.

In this way, it may be possible to achieve the technical advantage that a precise check of the safety zone or extended safety zone is made possible. To this end, geometric comparisons are made between the surface areas of the safety zones or extended safety zones and the safe travel corridor or the positions of the dynamic objects. In this way, it may be possible to accurately ascertain whether the safety zone is located entirely in the safe travel corridor or whether a dynamic object is located within the extended safety zone.

According to one specific embodiment of the present invention, static objects include infrastructure objects and/or parked vehicles, and dynamic objects include other road users.

In this way, it may be possible to achieve the technical advantage that static or dynamic objects which commonly occur in road traffic, in the form of static infrastructure objects or vehicles or other road users, may be taken into consideration.

According to one specific embodiment of the present invention, the static objects 311 are classified as potentially dynamic objects, wherein for potentially dynamic objects a probability of a dynamic behavior of the object at a future point in time is not equal to zero.

In this way, it may be possible to achieve the technical advantage that a distinction may be made between static objects, such as infrastructure objects, for which a potential dynamic behavior may be disregarded, and potentially dynamic objects, which at the time of detection are static, i.e. unmoving, but which may move at a later point in time. The potentially dynamic objects may be, for example, stationary pedestrians, who are not moving at the time the environment is captured but for whom the possibility that they might move at a future point in time may not be ruled out. The possible movement of the potentially dynamic objects may be taken into consideration when calculating the safe travel corridor and/or the safety zone or extended safety zone. This allows for a more precise calculation of the safe travel corridor and/or of the safety zones and hence for greater safety of the vehicle control.

According to one specific embodiment of the present invention, the surround sensor data include camera data, LiDAR data, radar data and/or acoustic data.

In this way, it may be possible to achieve the technical advantage that a precise object recognition is made possible.

According to a further aspect of the present invention, a processing unit is provided, which is set up to carry out the method for controlling an ego vehicle according to one of the above-described specific embodiments.

According to a further aspect of the present invention, a computer program product is provided, which comprises commands which, when the program is executed by a data processing unit, cause said unit to carry out the method for controlling an ego vehicle according to one of the above-described specific embodiments.

Exemplary embodiments of the present invention are explained by reference to the figures.

### BRIEF DESCRIPTION OF THE DRAWINGS

FIG. 1 shows a schematic representation of a system for controlling an ego vehicle according to a specific embodiment of the present invention.

FIG. 2 shows a further schematic representation of a system for controlling an ego vehicle according to a further specific embodiment of the present invention.

FIG. 3 shows a further schematic representation of a system for controlling an ego vehicle according to a further specific embodiment of the present invention.

FIG. 4 shows a further schematic representation of a system for controlling an ego vehicle according to a further specific embodiment of the present invention.

FIG. 5 shows a further schematic representation of a system for controlling an ego vehicle according to a further specific embodiment of the present invention.

FIG. 6 shows a flow chart of a method for controlling an ego vehicle according to an example embodiment of the present invention.

FIG. 7 shows a schematic representation of a computer program product, according to an example embodiment of the present invention.

### DETAILED DESCRIPTION OF EXAMPLE EMBODIMENTS

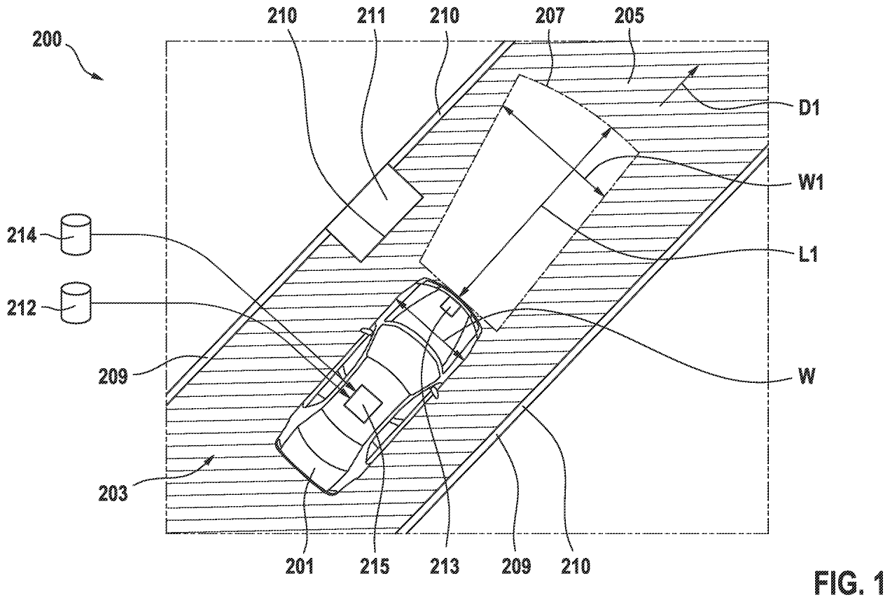

FIG. 1 shows a schematic representation of a system 200 for controlling an ego vehicle 201 according to a specific embodiment.

FIG. 1 shows an ego vehicle 201 traveling on a roadway 203 in direction of travel D1. Ego vehicle 201 comprises a processing unit 215, which is set up to carry out the method according to the present invention for controlling an ego vehicle 201. The ego vehicle further comprises at least one surround sensor 213.

In order to carry out the method 100 according to the present invention, map data 212 of a map display of the environment of ego vehicle 201 are first received by processing unit 215. Map data 212 map at least roadway 203 along which ego vehicle 201 is traveling. The map display may be a topological map or a feature map of the environment of ego vehicle 201, for example.

According to the present invention, a safe travel corridor 205 is calculated by processing unit 215 on the basis of map data 212. Safe travel corridor 205 describes a spatial area through which ego vehicle 201 may travel without collision. Safe travel corridor 205, which is calculated on the basis of map data 212 of the map display, is bounded at least by roadway boundaries 210 of roadway 203. Safe travel corridor 205 thus describes the drivable area of roadway 203 according to map data 212. Safe travel corridor 205 may further be limited to individual lanes of roadway 203, especially if they may be driven in different directions of travel.

According to the specific embodiment shown, safe travel corridor 205 is further calculated having regard to an object recognition performed on surround sensor data 214 of the at least one surround sensor 213. In the specific embodiment shown, at least one object 211 located at least partly on lane 203 is located in the environment of ego vehicle 201. According to the present invention, object 211 located at least partly on roadway 203 is recognized by a correspondingly trained object recognition system as a static object based on surround sensor data 214. Based on the results of the object recognition, detected object 211 is taken into consideration when calculating safe travel corridor 205. Boundaries 210 of travel corridor 205 are thus calculated having regard to detected static object 211. Safe travel corridor 205 is thus bounded at least by roadway boundaries 209 and by objects 211 located at least partly on roadway 203. Static objects 211 may be, for example, infrastructure objects or parked vehicles which are fixedly located in the environment of ego vehicle 201 but are not marked in the map display.

Furthermore, in accordance with the present invention, a safety zone 207 is calculated having regard to a state of movement of ego vehicle 201. Safety zone 207 describes a spatial area in which ego vehicle 201 in the given state of movement may be braked to a stop if an event occurs.

The state of movement of ego vehicle 201 includes the speed of ego vehicle 201, the position of ego vehicle 201, and also a retarding power of ego vehicle 201. The retarding power of ego vehicle 201 includes, in addition to a pure braking force of ego vehicle 201, the adhesion of ego vehicle 201 to a surface of lane 203, and influencing external factors such as weather conditions or roadway conditions.

A length L1 of safety zone 207 oriented in direction of travel D1 thus describes a braking distance that is needed if an event occurs to bring ego vehicle 201 to a safe stop while applying the full braking power of ego vehicle 201. In addition to the specified factors, a delay time describing a period between recognizing the occurrence of the event and performing the braking operation may be taken into account in order to calculate length L1 of the safety zone.

Moreover, a width W1 of safety zone 207, running in a direction perpendicular to direction of travel D1, takes into consideration a steering performance of ego vehicle 201. Width W1 of safety zone 207 takes into consideration possible steering inaccuracies of ego vehicle 201. The steering inaccuracies of ego vehicle 201 influence the control of ego vehicle 201. There is thus a connection between the steering inaccuracies of ego vehicle 201 and the spatial area that is needed for braking ego vehicle 201 to a stop. Higher steering inaccuracies thus lead to wider safety zones 207. According to one specific embodiment, width W1 of safety zone 207 is at least equal to the vehicle width of ego vehicle 201, however.

In the specific embodiment shown, safety zone 207 is rectangular or trapezoidal. This is by way of example only, however. Safety zone 207 may be of any shape.

To carry out the method according to the present invention for controlling ego vehicle 201, after calculating safety zone 207 for successive points in time of a journey by ego vehicle 201 along a planned travel trajectory, a check is made to determine whether safety zone 207 is located entirely within safe travel corridor 205. In the specific embodiment shown, for the position of ego vehicle 201 shown, safety zone 207 calculated with the state of movement of ego vehicle 201 is located entirely within safe travel corridor 205, which was calculated having regard to map data 212 and surround sensor data 214. If it were necessary to brake ego vehicle 201 from this position, ego vehicle 201 would be brought to a stop within the spatial area of safety zone 207. Ego vehicle 201 would thus remain entirely within safe travel corridor 205.

However, if the check shows that, over the course of the travel trajectory, calculated safety zone 207 is located at least partly outside calculated safe travel corridor 205, then according to the present invention a control signal is output to execute a safety maneuver.

The safety maneuver may include, for example, performing an emergency stop, where ego vehicle 201, deviating from the previously planned travel trajectory, is automatically brought immediately to a safe stop. Alternatively or in addition, the safety maneuver may include performing a speed reduction, where, again deviating from the previously planned travel trajectory, the speed of ego vehicle 201 is reduced in such a way that safety zone 207 is again located entirely within safe travel corridor 205. As described above, length L1 of safety zone 207 describes a braking distance needed to fully brake ego vehicle 201 in the current state of movement. Thus, if the speed of ego vehicle 201 is reduced, the required braking distance is reduced accordingly, such that length L1 of safety zone 207 is likewise reduced by the speed reduction. Consequently, with a corresponding reduction in speed, length L1 of safety zone 207 may be reduced in such a way that the correspondingly reconfigured safety zone 207 is once again located within safe travel corridor 205. Alternatively or in addition, the safety maneuver may include a steering movement of ego vehicle 201 deviating from the travel trajectory. As described above, the orientation and/or shape of safety zone 207 is dependent on the direction of travel of ego vehicle 201 in the given state of movement. If the direction of travel of ego vehicle 201 is changed, a reorientation of safety zone 207, which follows the direction of travel of ego vehicle 201, likewise occurs, as a result of which the newly generated safety zone 207 may once again be located within safe travel corridor 205.

According to one specific embodiment, both safe travel corridor 205 and safety zone 207 are calculated continuously as ego vehicle 201 travels along the planned travel trajectory, having regard to the map data and the state of movement of ego vehicle 201, and adapted to the current map data 212 and the current state of movement.

According to one specific embodiment, the detected objects may also be classified as potentially dynamic objects. The potentially dynamic objects may be, for example, standing pedestrians or stationary vehicles, which may move at a future point in time. The possible movement of the potentially dynamic objects may be taken into consideration in calculating the safe travel corridor, the safety zone or the extended safety zone. This allows for a more precise calculation of the safe travel corridor and/or of the safety zones and hence for greater safety of the vehicle control. To take account of the potential movement of a potentially dynamic object positioned in the environment of ego vehicle 201, the size of safe travel corridor 205 may be reduced, in order thereby to take account of the potential movement of the object in a direction of the potentially dynamic object oriented towards ego vehicle 201. The surface area of extended safety zone 117 may be increased accordingly, in order thereby to take account of the possible movement of the object in the direction of ego vehicle 201.

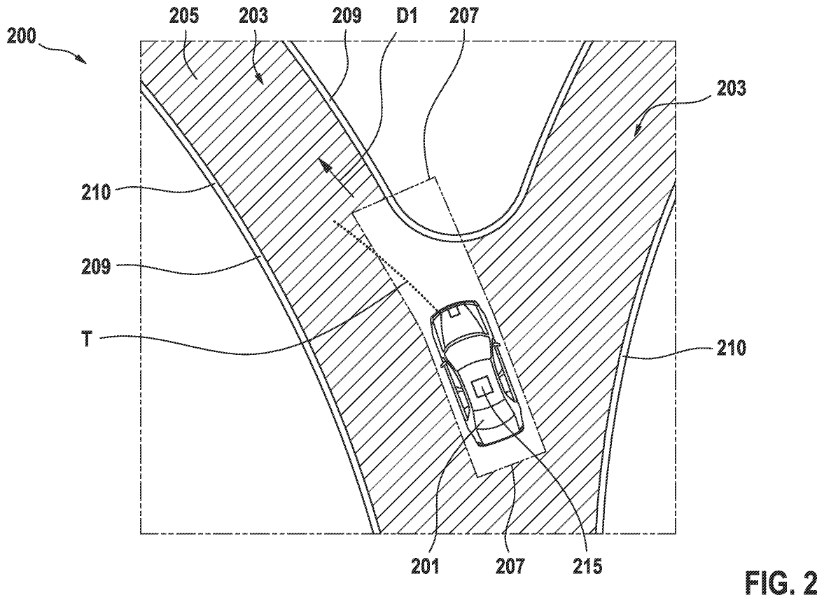

FIG. 2 shows a further schematic representation of a system 200 for controlling an ego vehicle 201 according to a further specific embodiment.

FIG. 2 shows a representation of ego vehicle 201 on a roadway 203. The representation shown is based on the specific embodiment in FIG. 1 and includes all the features presented therein. To simplify the representation, not all the features from FIG. 1 are shown explicitly.

In the specific embodiment shown, ego vehicle 201 is traveling along a previously planned travel trajectory T. In a manner analogous to that described above, a safe travel corridor 205 is calculated on the basis of map data 212 of the map display, said corridor being bounded in the specific embodiment shown by roadway boundaries 209. Furthermore, a corresponding safety zone 207 is calculated on the basis of the current state of movement of ego vehicle 201. In the specific embodiment shown, safety zone 207 is located immediately in front of and immediately behind ego vehicle 201 in direction of travel D1.

FIG. 2 illustrates the situation whereby, over the course of travel trajectory T, safety zone 207 calculated on the basis of the state of movement of ego vehicle 201 is no longer located entirely within the calculated safe travel corridor 205. In the representation shown, the front right corner of safety zone 207 with respect to direction of travel D1 of ego vehicle 201 extends beyond the borders of safe travel corridor 205 and is thus located outside safe travel corridor 205.

If ego vehicle 201 were to brake in the position shown, it would be possible for ego vehicle 201 to be brought to a stop within safety zone 207. However, since this might require the full length L1 of safety zone 207, ego vehicle 201 would thus only come to a stop partly outside safe travel corridor 205. The possibility of collisions with objects outside safe travel corridor 205 could therefore no longer be ruled out.

According to the present invention, on detecting that the safety zone is no longer located entirely in safe travel corridor 205, as shown, the aforementioned control signal to execute the safety maneuver is output. Since a delay time between recognizing the occurrence of an event and triggering the braking operation is taken into consideration when calculating length L1 of safety zone 207, then if the safety maneuver in the form of an emergency stop is executed immediately after recognizing that safety zone 207 is located at least partly outside safe travel corridor 205, ego vehicle 201 is brought to a stop within safety zone 207 without requiring the full length L1 of safety zone 207. By executing the safety maneuver it is thus possible for ego vehicle 201 to remain within safe travel corridor 205.

According to one specific embodiment, the check that safety zone 207 is located in safe travel corridor 205 may be made by way of geometric comparisons between the surface area of safety zone 207 and the surface area of safe travel corridor 205.

This check to ensure that safety zone 207 is located in safe travel corridor 205 as ego vehicle 201 follows the planned travel trajectory enables incorrectly calculated travel trajectories, which lead to unsafe driving behavior, to be detected and an emergency stop of ego vehicle 201 to be performed before a dangerous situation arises for ego vehicle 201.

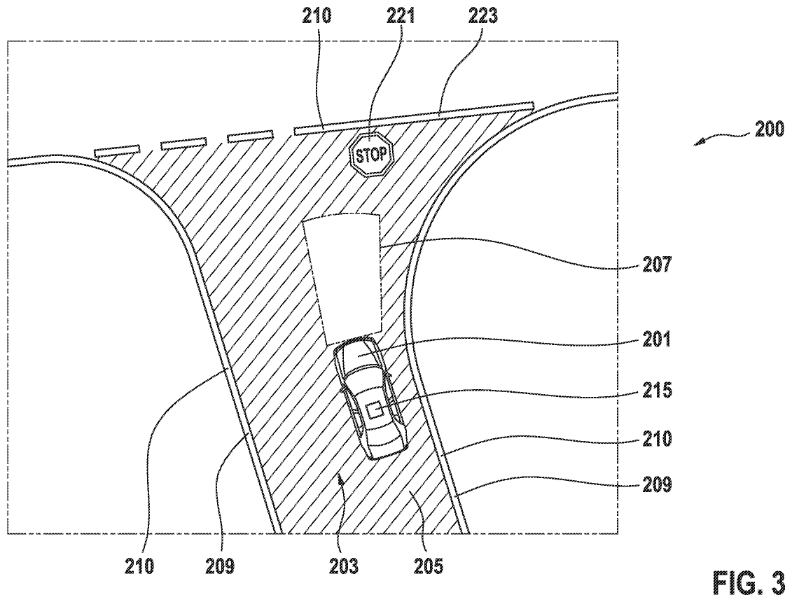

FIG. 3 shows a further schematic representation of a system 200 for controlling an ego vehicle 201 according to a further specific embodiment.

FIG. 3 shows a further specific embodiment of system 200. The specific embodiment shown is based on the embodiments in FIGS. 1 and 2. Once again, to simplify the representation, not all the features of the aforementioned specific embodiments are shown in FIG. 3.

According to the specific embodiment shown, surround sensor data 214 are also taken into consideration along with map data 212 of the map display to calculate safe travel corridor 205. In particular, when ascertaining safe travel corridor 205, prevailing traffic regulations identified by the object recognition performed on surround sensor data 214 of surround sensors 213 are applied.

In the specific embodiment shown, there is a road sign 221 in the form of a stop sign together with a corresponding stop line 223 on roadway 203. According to the present invention, the correspondingly calculated safe travel corridor 205 is thus bounded by the detected stop line 223 of stop sign 221 as well as by roadway boundaries 209. As an alternative to the specific embodiment shown, other traffic regulations that commonly occur in road traffic may be taken into consideration. For example, safe travel corridor 205 may be limited to individual lanes of roadway 203.

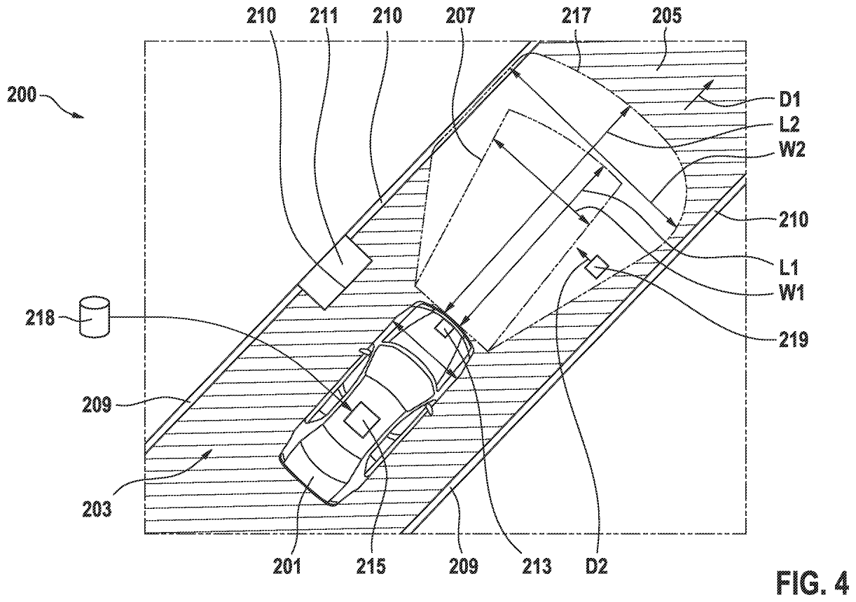

FIG. 4 shows a further schematic representation of a system 200 for controlling an ego vehicle 201 according to a further specific embodiment.

The specific embodiment in FIG. 4 is based on the specific embodiments described above and includes all the features described therein. In the specific embodiment shown, in addition to safety zone 207 based on the state of movement of ego vehicle 201, an extended safety zone 217 is calculated, having regard to an object movement model 218. Extended safety zone 217 serves here to take account of dynamic objects 219 located in the environment of ego vehicle 201. The object movement model describes average movement behaviors or patterns of movement of dynamic objects 219 located in the environment of ego vehicle 201. The extended safety zone thus describes a spatial area within which, on detection of an object 219 moving dynamically in accordance with object movement model 218, ego vehicle 201 in the current state of movement may be brought to a stop without colliding with detected object 219.

As a result of considering dynamic objects 219 when calculating extended safety zone 217, extended safety zone 217 is largely pear-shaped, a width W2 of extended safety zone 217 increasing with the distance from ego vehicle 201. The fact that width W2 increases with the distance from ego vehicle 201 means that the direction of travel D2 of dynamic object 219 relative to ego vehicle 201 is taken into consideration.

In the specific embodiment shown, extended safety zone 217 is calculated only for the region within safe travel corridor 205. This means that only dynamic objects 219 within safe travel corridor 205 are taken into consideration.

According to the present invention, when calculating extended safety zone 217, a check is made to ascertain whether a dynamic object 219 is located within extended safety zone 217. If a dynamic object 219 is found to be located within extended safety zone 217, the aforementioned control signal to execute the safety maneuver is output. As a result of considering the movement of dynamic object 219 in the form of object movement model 218, extended safety zone 217 has a larger surface area than safety zone 207. According to the present invention, extended safety zone 217 may be located immediately in front of, behind or alongside ego vehicle 201 with respect to direction of travel D1 of ego vehicle 201. Collisions with dynamic objects 219 located in front of, behind or alongside ego vehicle 201 with respect to direction of travel D1 of ego vehicle 201 may be prevented in this way.

According to the present invention, consideration is given to the movement of dynamic objects 219 solely by way of object movement model 218. No behavior prediction of future behaviors of dynamic objects 219 is made. Instead, object movement model 218 describes an average movement of dynamic objects 219 within the environment of ego vehicle 201.

The consideration of extended safety zone 217 serves here as a safety function that may be performed in parallel with predicting the behavior of dynamic objects 219. Immediately upon detection of a dynamic object 219 in extended safety zone 217, the control signal to execute the safety maneuver is output. This takes place independently of the behavior prediction that is made.

Dynamic objects 219 that are taken into consideration may be, for example, other road users and particularly pedestrians.

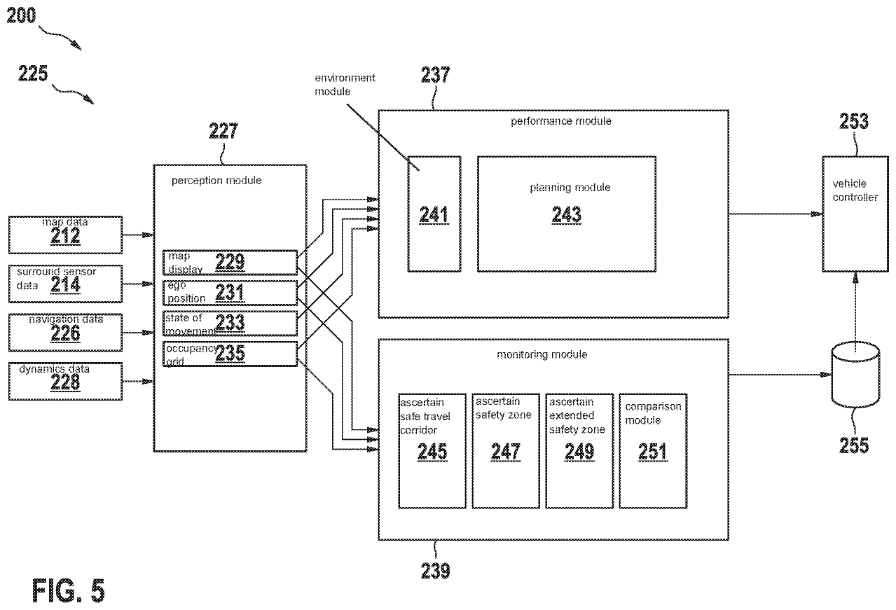

FIG. 5 shows a further schematic representation of a system 200 for controlling an ego vehicle 201 according to a further specific embodiment.

FIG. 5 shows an architecture 225 of system 200 for controlling an ego vehicle 201. The architecture comprises a perception module 227. Perception module 227 creates a map display 229 of the environment of ego vehicle 201, based on map data 212. Furthermore, an ego position 231 is ascertained on the basis of navigation data 226. Moreover, a state of movement 233 of ego vehicle 201 is ascertained on the basis of dynamics data 228 relating to ego vehicle 201. Dynamics data 228 may include speed information, position information or other information influencing the state of movement. Furthermore, an occupancy grid 235 of the environment of ego vehicle 201, with which objects 211, 219 within the environment of ego vehicle 201 may be detectable, is calculated on the basis of surround sensor data 214 of surround sensors 213 of ego vehicle 201.

Furthermore, architecture 225 includes a performance module 237. Performance module 237 includes an environment model 241 which enables the environment of ego vehicle 201 to be described. Performance module 237 further includes a planning module 243 for planning a travel trajectory to be executed by ego vehicle 201.

Furthermore, architecture 225 includes a monitoring module 239. Monitoring module 239 comprises a module 245 for ascertaining safe travel corridor 205, a module 247 for ascertaining safety zone 207, a module 249 for ascertaining extended safety zone 217, and a comparison module 251 for comparing the geometric surface areas of safety zone 207 and safe travel corridor 205 and extended safety zone 217 with positions of detected objects 211, 219.

Based on map display 229, ego position 231, state of movement 233 and the information from occupancy grid 235, planning module 243 plans a travel trajectory T to be executed, having regard to environment model 241.

Furthermore, having regard to map display 229, ego position 231, state of movement 233 and occupancy grid 235, monitoring module 239 monitors the calculation of safe travel corridor 205, safety zone 207 and extended safety zone 217 and the comparison or check to ascertain whether safety zone 207 is entirely located in safe travel corridor 205 and whether objects 211, 219 are located in extended safety zone 217.

If it detects that safety zone 207 is not entirely located in safe travel corridor 205 and/or that an object 211, 219 is located in extended safety zone 217, monitoring module 239 outputs a control signal 255 to vehicle controller 253 to execute the safety maneuver. If control signal 255 to execute the safety maneuver is output, vehicle controller 253 abandons the planned travel trajectory T previously output by planning module 237 and brings ego vehicle 201 immediately to a stop.

In the specific embodiment shown, performance module 237 and monitoring module 239 are designed as two separate paths. An independent monitoring by monitoring module 239 of the travel trajectories planned by planning module 237 is achieved in this way. This enables ego vehicle 201 to be driven safely, especially if planned travel trajectories have been incorrectly calculated.

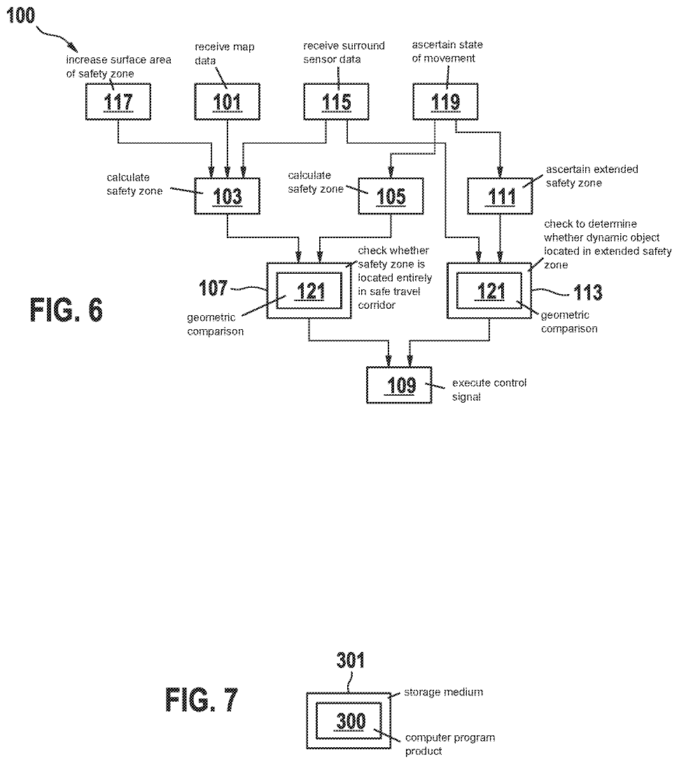

FIG. 6 shows a flow chart of a method 100 for controlling an ego vehicle 201.

According to the present invention, firstly, map data 212 of a map display of an environment of ego vehicle 201 are received in a first method step 101. Map data 212 map at least one lane 203 along which ego vehicle 201 is traveling.

Moreover, in a further method step 117, position data are received and a position of ego vehicle 201 in relation to the map display is ascertained.

In a further method step 115, surround sensor data 214 are received from at least one surround sensor 213 of ego vehicle 201 and an object recognition is performed on the basis of surround sensor data 214.

In a further method step 119, a state of movement of ego vehicle 201 is ascertained. The state of movement of ego vehicle 201 is defined by a speed, a position, and also information relating to a braking behavior or retarding power of ego vehicle 201.

In the specific embodiment shown, in a further method step 103, a safety zone 207 is calculated on the basis of map data 212 received, in combination with the position of ego vehicle 201 relative to the map display and having regard to objects 211 ascertained by the object recognition. Safety zone 207 describes a spatial area through which ego vehicle 201 may travel without collision. In the specific embodiment shown, safety zone 207 is bounded by roadway boundaries 209 and by objects 211 located at least partly on roadway 203.

Furthermore, in a method step 105, a safety zone 207 of ego vehicle 201 is calculated on the basis of the state of movement of ego vehicle 201. Safety zone 207 describes a spatial area in which the ego vehicle may be brought to a stop in the current state of movement.

Moreover, according to the specific embodiment shown, an extended safety zone 217 is calculated, having regard to the state of movement of ego vehicle 201 and having regard to an object movement model 218. Extended safety zone 217 describes a spatial area in which ego vehicle 201 may be brought to a stop without colliding with a dynamic object 219 within the environment of ego vehicle 201.

In a further method step 107, a check is made to determine whether safety zone 207 calculated in method step 105 is located entirely in safe travel corridor 205 calculated in method step 103.

To this end, in method step 121, a geometric comparison is made between the surface area of safety zone 207 and the surface area of safe travel corridor 205.

In a further method step 113, a check is made to determine whether a dynamic object 219 is located in extended safety zone 217 calculated in method step 111.

To this end, in the specific embodiment shown, a geometric comparison is made in method step 121 between a surface area of extended safety zone 217 and a position of dynamic object 219 recognized by the object recognition.

In a further method step 109, a control signal 255 to execute a safety maneuver is output if it is recognized in method step 107 that safety zone 207 is not located entirely in safe travel corridor 205 and/or if it is recognized in method step 113 that an object 211, 219 is located in extended safety zone 217. The safety maneuver may comprise an emergency stop, a speed reduction, or a steering maneuver.

The surround sensor data may include LiDAR data, radar data, camera data, or acoustic data.

Static objects 211 may include infrastructure objects or parked vehicles, dynamic objects 219 may include other road users, particularly pedestrians.

FIG. 7 shows a schematic representation of a computer program product 300 comprising commands which, when the program is executed by a processing unit, cause it to carry out the method 100 for controlling an ego vehicle 201.

In the specific embodiment shown, computer program product 300 is stored on a storage medium 301. Storage medium 301 may be any conventional storage medium from the related art.

What is claimed is:

1. A method for controlling an ego vehicle, comprising the following steps:
receiving map data of a map display of an environment of the ego vehicle, the map data of the map display mapping at least one roadway along which the ego vehicle is traveling;
ascertaining a safe travel corridor for the ego vehicle based on the map data of the map display, the safe travel corridor describing a spatial area through which the ego vehicle may travel without collision, and the safe travel corridor being bounded at least by boundaries of the roadway;
ascertaining a safety zone of the ego vehicle based on a state of movement of the ego vehicle, the safety zone defining a spatial area in which the ego vehicle may be safely brought to a stop in the state of movement;
checking whether, when the ego vehicle is traveling along a travel trajectory, the safety zone is located entirely within the safe travel corridor; and
outputting a control signal to execute a safety maneuver based on the safety zone being located at least partly outside the safe travel corridor.

2. The method as recited in claim 1, wherein the safety maneuver includes:
performing an emergency stop, where the ego vehicle, deviating from a planned travel trajectory, is brought to a safe stop; and/or
performing a speed reduction deviating from a planned travel trajectory of the ego vehicle, the speed reduction being performed in such a way that the safety zone is located entirely within the safe travel corridor; and/or
performing a steering movement deviating from the planned travel trajectory of the ego vehicle, the steering movement being performed in such a way that the safety zone is located entirely within the safe travel corridor.

3. The method as recited in claim 1, wherein, by way of an object recognition performed on surround sensor data of at least one surround sensor of the ego vehicle, at least one static object located at least partly on the roadway is recognized, the safe travel corridor being bounded by the at least one static object located at least partly on the roadway.

4. The method as recited in claim 3, wherein, by way of the object recognition performed on the surround sensor data of the at least one surround sensor of the ego vehicle, at least one prevailing traffic regulation is recognized, the safe travel corridor being bounded by the at least one recognized prevailing traffic regulation.

5. The method as recited in claim 3, further comprising the following steps:
ascertaining an extended safety zone based on the state of movement of the ego vehicle and having regard to an object movement model for dynamic objects, the object movement model including a description of an average movement of dynamic objects located in the environment of the ego vehicle, the extended safety zone defining a spatial area in which the ego vehicle in the state of movement may be brought to a stop without colliding with a dynamic object which according to the object movement model is moving at least partly in the direction of the ego vehicle;
checking whether a dynamic object located in the environment of the ego vehicle is located within the extended safety zone; and
outputting the control signal to execute a safety maneuver based on the safety zone being located at least partly outside the safe travel corridor and/or based on at least one dynamic object being located in the extended safety zone.

6. The method as recited in claim 1, wherein the state of movement is defined at least by an item of position information and/or speed information and/or retardation information relating to a possible retarding power of the ego vehicle, a length of the safety zone oriented in a direction of travel of the ego vehicle corresponding to a distance within which, if an event occurs, the ego vehicle in the state of movement may be brought to a stop by applying a maximum retarding power of the ego vehicle.

7. The method as recited in claim 5, wherein a length of the extended safety zone oriented in a direction of travel of the ego vehicle and/or a width of the extended safety zone oriented perpendicularly to the direction of travel of the ego vehicle corresponds to a distance within which the ego vehicle in the state of movement may be brought to a stop with the maximum retarding power without colliding with an object which, according to the movement model, is moving towards the ego vehicle at least partly in an opposite travel direction or in a direction perpendicular to the direction of travel.

8. The method as recited in claim 5, wherein a width of the safety zone oriented perpendicularly to a travel direction of the ego vehicle and/or a width of the extended safety zone, corresponds at least to a width of the ego vehicle.

9. The method as recited in claim 5, wherein the safety zone and/or the extended safety zone includes a spatial area immediately in front of and/or behind and/or alongside the ego vehicle in a direction of travel of the ego vehicle.

10. The method as recited in claim 1, wherein the state of movement includes an item of steering information relating to a possible steering performance of the ego vehicle, the width of the safety zone being ascertained having regard to a steering inaccuracy of the ego vehicle.

11. The method as recited in claim 5, wherein the checking of the location of the safety zone within the safe travel corridor and/or the checking of the positioning of the dynamic object in the extended safety zone takes place by way of a geometric comparison between a surface area of the safety zone and a surface area of the safe travel corridor and/or by way of a geometric comparison between a surface area of the extended safety zone and a position of the dynamic object.

12. The method as recited in claim 5, wherein the at least one static object includes infrastructure objects and/or parked vehicles and/or temporary objects, such as garbage containers or lost cargo and/or vehicle parts, and wherein the dynamic objects include other road users.

13. The method as recited in claim 5, wherein the at least one static object is classified as a potentially dynamic object, and wherein for the potentially dynamic object a probability of a dynamic behavior of the object at a future point in time is not equal to zero.

14. The method as recited in claim 1, wherein the surround sensor data include camera data and/or LiDAR data and/or radar data and/or acoustic data.

15. A processing unit including a processor configured to control an ego vehicle, the processing unit configured to:
receive map data of a map display of an environment of the ego vehicle, the map data of the map display mapping at least one roadway along which the ego vehicle is traveling;
ascertain a safe travel corridor for the ego vehicle based on the map data of the map display, the safe travel corridor describing a spatial area through which the ego vehicle may travel without collision, and the safe travel corridor being bounded at least by boundaries of the roadway;
ascertain a safety zone of the ego vehicle based on a state of movement of the ego vehicle, the safety zone defining a spatial area in which the ego vehicle may be safely brought to a stop in the state of movement;
check whether, when the ego vehicle is traveling along a travel trajectory, the safety zone is located entirely within the safe travel corridor; and
output a control signal to execute a safety maneuver based on the safety zone being located at least partly outside the safe travel corridor.

16. A non-transitory computer-readable medium on which is stored a computer program including commands for controlling an ego vehicle, the computer program, when executed by a data processor, causing the data processor to perform the following steps:
receiving map data of a map display of an environment of the ego vehicle, the map data of the map display mapping at least one roadway along which the ego vehicle is traveling;
ascertaining a safe travel corridor for the ego vehicle based on the map data of the map display, the safe travel corridor describing a spatial area through which the ego vehicle may travel without collision, and the safe travel corridor being bounded at least by boundaries of the roadway;
ascertaining a safety zone of the ego vehicle based on a state of movement of the ego vehicle, the safety zone defining a spatial area in which the ego vehicle may be safely brought to a stop in the state of movement;
checking whether, when the ego vehicle is traveling along a travel trajectory, the safety zone is located entirely within the safe travel corridor; and
outputting a control signal to execute a safety maneuver based on the safety zone being located at least partly outside the safe travel corridor.
